(19) United States
(12) Patent Application Publication
(10) Pub. No.: US 2026/0008321 A1
(43) Pub. Date: Jan. 8, 2026

(54) CONVECTIVE HEATING MODULE

(71) Applicant: Gentherm GmbH, Odelzhausen (DE)

(72) Inventors: Christian CONDE-SILVA, Ferndale, MI (US); Kevin KRACH, South Lyon, MI (US)

(21) Appl. No.: 19/125,904

(22) PCT Filed: Dec. 8, 2023
(86) PCT No.: PCT/IB2023/062409

§ 371 Date: Apr. 30, 2025

Related U.S. Application Data
(60) Provisional application No. 63/433,522, filed on Dec. 19, 2022.

(51) Int. Cl. B60H 1/22

(52) U.S. Cl. CPC B60H 1/2225

(57) ABSTRACT

A heating module comprising a housing and a sensor. The housing comprises a first portion in which a printed circuit board assembly is located, a second portion in which a heating element is located, and a channel extending from the first portion toward the second portion. The sensor is connected to the printed circuit board assembly via a wire extending through the channel and is exposed at an end of the channel.

### CROSS-REFERENCE TO RELATED APPLICATIONS

This application is a national phase application of International Application Number PCT/IB2023/062409 (filed Dec. 8, 2023), which claims priority to U.S. Provisional Application No. 63/433,522 (filed Dec. 19, 2022), incorporated herein by reference in their entirety for all purposes.

### FIELD

The present disclosure relates to a convective heating module operative in a vehicle and a sensor arrangement for the same.

### BACKGROUND

Larger automotive vehicles typically contain auxiliary HVAC units to condition second and third row occupants. Typically, these auxiliary HVAC units rely upon liquid coolant supplied from an internal combustion engine cooling system. In this regard, coolant lines run through the vehicle from the engine to the HVAC unit. Coolant heated by the engine flows to a heater core located within the HVAC unit and exchanges heat with an airflow. Challenges with coolant lines and heater cores include their cost and manufacturing complexity.

Heater cores supplied by liquid battery cooling systems can be employed in fully electric vehicles, but batteries typically do not generate as much heat as internal combustion engines. Moreover, hybrid vehicles, in which internal combustion engines are not constantly operational during driving, may not generate as much heat as non-hybrid internal combustion engine vehicles. Thus, limits are realized for conditioning occupants.

Conventional vehicles are being provided with an increasing quantity of occupant comfort systems. These systems are located in various parts of a vehicle including dashboards, steering wheels, vehicle seats, headrests, roofs, pillars, and the like. Each of these locations have specific packaging space requirements. Due to the size of some conventional HVAC units (e.g., those relying on coolant lines and heater cores), fitting into these packaging spaces may be difficult or perhaps not possible.

In some applications only small volumes of airflow are required to suitably condition an occupant due to the size of the body region being conditioned and/or the anatomy of the body region (e.g., the degree of vascularity and/or characteristics of the nervous system in a given region of the body relates to heat exchanges with the body). One such application includes the conditioning of a passenger's legs. Thus, smaller HVAC units may be used. However, some conventional HVAC units (e.g., those relying on coolant lines and heater cores) have a lower limit in their size.

An electrically powered heating element is one alternative to liquid-based systems that draw heat from sources such as internal combustion engines and batteries. Typically, these systems employ printed circuit board assemblies (“PCBAs”) to at least control the operation of the heating element and a fluid moving device that forces air over and/or through the heating element.

Temperature sensors are typically used to operate the fluid moving device and heating element. For instance, the ambient air temperature within a vehicle cabin can be compared to a setpoint temperature. In this regard, the temperature of the heating element and/or the speed of the fluid moving device may be adjusted.

One challenge is realized in the location of sensors such that accurate measurements are obtained and/or damage to the sensors can be avoided. Regarding accuracy, it is understood that heating elements, PCBAs, and fluid moving devices generate waste heat that may influence sensor measurements. While in some circumstances heat may be drawn away from the system by convective airflow, heat may still migrate to sensors in the form of radiation and/or by conductively travelling through components of the system (e.g., the housing).

Simplifying manufacturing complexity and preventing erroneous assembly continues to be an interest in the automotive industry. This is particularly felt with assembling wiring and small components such as sensors.

It would be desirable to provide a heating module that operates without liquid coolant so that coolant lines and a heater core may be eliminated.

It would be desirable to provide a heating module that can be employed in internal combustion engine, hybrid, and fully electric vehicles.

It would be desirable to provide a heating module with a smaller packaging space as compared to liquid-based heating modules.

It would be desirable to provide a heating module that can fit underneath or within a vehicle seat.

It would be desirable to provide a heating module that can effectuate an airflow upon an occupant's legs and/or other body parts.

It would be desirable to locate sensors and the wires thereof to protect the same from contact and/or damage during assembly and/or use of the heating module.

It would be desirable to locate sensors to prevent or at least mitigate influence from waste heat such as that produced by PCBAs, fluid moving devices, heating elements, and the like.

It would be desirable to locate sensors such that they can obtain accurate measurements of ambient air within the cabin.

It would be desirable to provide a heating module constructed to prevent or at least mitigate improper assembly.

### SUMMARY

The present disclosure provides for a heating module that may address at least some of the needs identified above.

The heating module may comprise a housing and a sensor.

The housing may comprise a first portion in which a printed circuit board assembly is located, a second portion in which a heating element is located, and a channel extending from the first portion toward the second portion. The first portion and the second portion may respectively define discrete enclosures.

A sensor may be connected to the printed circuit board assembly via a wire extending through the channel. The sensor may be exposed at an end of the channel.

The channel may connect the first portion and the second portion.

The sensor may measure ambient air received into the second portion of the housing via a blower.

The sensor may extend into an airflow generated by the blower and travelling between opposing ends of the second portion.

The sensor may be located upstream of the heating element and downstream of the blower.

The sensor may be located proximate to an outlet of the blower and/or a parting line between the outlet of the blower and the second portion.

The end of the channel, being a first end, may be proximate to the outlet of the blower and/or the parting line. A second end of the channel may be proximate to a connection point of the wire to the printed circuit board assembly.

The channel may have a stepped shape, linear shape, curved shape, or any combination thereof.

The sensor may be a first sensor, and the heating module may comprise a second sensor connected to the printed circuit board assembly. The second sensor may be exposed at the first end of the channel.

The housing may comprise a first segment and a second segment, which fasten together to define enclosures within the first portion, the second portion, and the channel. The first segment and the second segment may fasten together by snap connections integrally formed to the first and second shells, separate fasteners, or both.

The channel may comprise a partition that separates the wire of the first sensor and the wire of the second sensor. The partition may define a first and second sub-channel through which the wire of the first sensor and the wire of the second sensor respectively extend. The partition may project from the first segment or the second segment. The partition may extend at least partially between the first and second ends of the channel. The partition may extend partially between the first and second segments such that a gap is defined between a free end of the partition and the first or second segment, whichever the partition does not extend from.

The first and second sub-channels may each comprise one or more retention features. The one or more retention features may project from a wall of the first and second sub-channels and/or project from the partition. The one or more retention features may define spaces between the one or more retention features and the wall and/or the one or more retention features and the partition. The spaces may have a dimension that is less than a cross-sectional dimension, respectively, of the wires of the first and second sensor such that the wires may be pinched within the spaces.

The one or more retention features may have a profile of a circular segment, square, rectangle, triangle, or any combination thereof.

The one or more retention features may alternate, along a length of the first and second sub-channels, in projecting from the wall of the first and second sub-channels and projecting from the partition.

The one or more retention features may be located on the first segment and/or second segment of the housing.

The channel may comprise a first trench for the first sensor and a second trench for the second sensor. The first and second trenches respectively may secure the first and second sensors. Cross-sectional dimensions of the first and second trenches may be less than largest dimensions of the first and second sensors such that the first and second sensors are prevented from retracting into the first and second sub-channels.

The first and second trenches may be defined by a reduced cross-sectional dimension relative to the first and second sub-channels. The first and second trenches respectively may include a first and second chamfer transitioning from the cross-sectional dimension of the first and second sub-channels to the reduced cross-sectional dimensions of the first and second trenches.

The one or more retention features in each of the first and second sub-channels may include a retention feature in each of the first and second sub-channels located proximate to the chamfer such that the area defined between the retention feature in each of the first and second sub-channels and the first and second chamfers is less than a dimension of the first and second sensors, respectively.

The first and second trenches may be separated by a wall that maintains a spacing between the first and second sensors.

The blower may provide a first airflow to the first portion of the housing containing the printed circuit board assembly, and a second airflow to the second portion of the housing containing the heating element.

The first airflow may draw heat away from the printed circuit board assembly. The second airflow may be heated by the heating element and expelled from the heating module to thermally condition a passenger of a vehicle. Signals from the first and second sensors may be employed to control the speed of an impeller of the blower and/or the temperature of the heating element.

### BRIEF DESCRIPTIONS OF THE DRAWINGS

FIG. 1A is a perspective view of a heating module according to the present disclosure.

FIG. 1B is a perspective view of the heating module according to the present disclosure.

FIG. 1C is a perspective view of the heating module according to the present disclosure.

FIG. 2 is a perspective view of the heating module as shown in FIG. 1B, with the second and third segments of the housing removed.

FIG. 3 is a plan view of the second segment of the housing.

FIG. 4 is a close-up, plan view of the channel shown in FIG. 2.

FIG. 5A is a sectional view of the heating module of FIG. 1B, along line A-A.

FIG. 5B is a sectional view of the heating module of FIG. 1B, along line B-B.

FIG. 6 is a plan view of a vehicle comprising the heating module according to the present teachings.

### DETAILED DESCRIPTION

The heating module of the present disclosure may be employed in a vehicle. Some of the benefits of the heating module discussed herein may be realized in hybrid and/or fully electric vehicles but it is contemplated that the heating module may also be used in internal combustion engine vehicles. The vehicles may include, but are not limited to, sedans, crossovers, sports utility vehicles, pickup trucks, trucks, mini-vans, vans, busses, construction vehicles, recreational off-highway vehicles, the like, or any combination thereof.

The vehicles may include a cabin. The cabin may be any compartment in which occupants are situated. The ambient air may be present in and/or circulate within the cabin. Ambient air, as referred to herein, may mean any air within the cabin surrounding occupants or any body parts thereof.

By way of example, where the heating module is located underneath or within the seat, ambient air may be drawn into the heating module from underneath the seat, behind the seat, on the sides of the seat, or any combination thereof.

A fluid moving device may draw in ambient air from the cabin. The fluid moving device may cause air to flow through a housing and/or the elements thereof. The fluid moving device may cause air to flow across a PCBA. In this regard, waste heat may be drawn away from the PCBA. The fluid moving device may cause air to flow through or across one or more heating elements and/or heat exchangers. In this regard, the airflow may be heated and ultimately delivered to an occupant.

The ambient air may be conditioned. The ambient air may be conditioned by exchanging heat with heating elements. The ambient air may flow through the heating module without being conditioned. That is, the heating elements may not be operational. Thus, ambient air flowing over and/or through the heating elements and/or heat exchangers may remain un-conditioned.

The conditioned and/or un-conditioned air may be delivered to a vehicle cabin. The conditioned and/or un-conditioned air may be delivered to an occupant. The conditioned and/or un-conditioned air may be delivered to any body part of an occupant. The body part may include a head, a torso, one or more appendages (e.g., arms and legs), or any combination thereof. The conditioned and/or un-conditioned air may provide heat to or draw heat from an occupant.

The conditioned and/or un-conditioned air may be delivered to a footwell. Footwell, as referred to herein, may mean a region below a seating surface plane where at least a portion of an occupant's legs (e.g., the calves and feet) are situated when the occupant is seated.

The vehicle may include one or more vehicle seats. The vehicle seats may be located in a first, second, or third row of a vehicle. The vehicle seats may comprise a frame. The frame may function to structurally reinforce the seat, support cushions, support occupants, or any combination thereof. The seat may comprise a cushion upon which an occupant may be seated.

There may be an open space located underneath the seat. The open space may be filled with ambient air. Air employed by the heating module of the present disclosure may be drawn at least from underneath the seat. Although the present disclosure does not foreclose air being drawn from other portions of the cabin (e.g., behind the seat and/or on the sides of the seat).

At least a portion of the frame may be exposed on an underside of the seat. The heating module of the present disclosure may be attached to the frame of the seat. At least a portion of the heating module of the present disclosure may be packaged within a cushion of the seat.

The present disclosure provides for a heating module. The heating module may function to provide heat to the body of a vehicle occupant, draw heat from the body of a vehicle occupant, draw heat from a PCBA, or any combination thereof. Whether providing heat to, or drawing heat from an occupant, these functions may be referred to herein, individually or in combination, as conditioning an occupant (i.e., influencing a heat transfer relative to the occupant).

The heating module may condition any body part of an occupant. The heating module may condition a head, a torso, one or more appendages (e.g., arms and legs), or any combination thereof. The heating module may condition calves, shins, feet, knees, popliteal regions, or any combination thereof. The small packaging space realized by the heating module of the present teachings may be advantageous for being located under on in a seat for conditioning legs, although other locations are contemplated by the present teachings.

While the present disclosure may refer to a heating module, it is understood that the module may operate in a mode in which a heating element is not operational, but a fluid moving device is operational. In effect, ambient air may be provided to the occupant to provide cooling by drawing heat from an occupant.

The heating module of the present disclosure may have a small packaging size relative to some conventional HVAC modules. In this regard, the heating module may be packaged underneath and/or within a seat.

The heating module may have a length of about 180 mm or more, 190 mm or more, 200 mm or more, or even 210 mm or more. The heating module may have a length of about 260 mm or less, 250 mm or less, 240 mm or less, or even 230 mm or less.

The heating module may have a width of about 190 mm or more, 200 mm or more, or even 210 mm or more. The heating module may have a width of about 150 mm or less, 140 mm or less, or even 130 mm or less.

The heating module may have a height of about 20 mm or more, 30 mm or more, or even 40 mm or more. The heating module may have a height of about 70 mm or less, 60 mm or less, or even 50 mm or less.

The heating module may comprise one or more heating elements, one or more heat exchangers, a fluid moving device, a housing including one or more segments thereof, one or more channels, one or more inlets, one or more outlets, one or more conduits, a diffuser, one or more PCBAs, or any combination thereof.

The heating module may comprise one or more heating elements. The heating elements may include one or more, two or more, or even three or more heating elements. The heating elements may function to generate heat, exchange heat with air, conduct heat to one or more heat exchangers, or any combination thereof.

The heating elements may be fabricated of a resistive material. The material may be provided in the form of a plate, wire, deposited (e.g., printed) lines of material, the like, or any combination thereof. The heating elements may include resistive wire heating elements, ceramic heating elements, thick film heating elements, polymer heating elements, the like, or any combination thereof. The heating elements may be positive temperature coefficient heating elements although other types of electronically powered heating elements are contemplated by the present teachings.

The heating elements may be powered by electricity. The heating elements may be powered via a printed circuit board assembly (“PCBA”) as disclosed herein. The heating element may connect to a PCBA at one or more connection points. The PCBA may comprise one or more power connectors drawing energy from the vehicle. Thus, the heating elements connected to the PCBA may be powered via the PCBA.

The heating elements may have a heating capacity of about 250 W or more, 300 W or more, or even 350 W or more. The heating elements may have a heating capacity of about 500 W or less, 450 W or less, or even 400 W or less.

The heating elements may comprise one or more connectors. There may be one connector per heating element. The connectors may function as a mounting surface for one or more wires, to provide electricity to the heating elements, or both. The connectors may comprise a surface to which wires may be attached. The connectors may be in the form of tabs extending from the heating elements.

The connectors may extend toward a printed circuit board assembly. The connectors may terminate within a heating element potion of the housing. The connectors may extend into a PCBA portion of the housing. The connectors may extend from the heating element portion into the PCBA portion.

Wires may be attached at one end to the connectors and at another end to the printed circuit board assembly. The wires may be attached by conductive adhesive, soldering, clips, harnesses, the like, or any combination thereof. The wires may extend through the heating element portion of the housing, the PCBA portion of the housing, or both.

One or more heating elements may be located in a conduit of a heating element portion of the housing. The heating elements may be located proximate to an inlet of the heating element portion, proximate to an outlet of the heating element portion, or anywhere therebetween. The heating elements may extend between any two opposing sides of the conduit or any distance therebetween.

The heating module may comprise one or more heat exchangers. The heat exchangers may function to conduct heat from heating elements, exchange heat with air flowing through the heat exchangers, or both. The heat exchangers may comprise a corrugated material, although the present disclosure contemplates any suitable form of heat exchanger. The heat exchangers may be adapted to provide an airflow therethrough. The heat exchangers may be fabricated from a thermally conductive material. The thermally conductive material may include metal. The metal may include steel, copper, brass, aluminum, alloys thereof, the like, or any combination thereof.

The heat exchangers may contact the heating elements. The heat exchangers may be in thermally conductive communication with the heating elements. A heat exchanger may be disposed between two heating elements. A heating element may be disposed on only one side of one or more of the heat exchangers.

The heating module may comprise one or more fluid moving devices. The fluid moving devices may also be referred to herein as blowers. The fluid moving device may function to uptake air (e.g., ambient air) from a cabin of a vehicle, provide air to heating elements, provide air to a printed circuit board assembly, provide air to an occupant of a vehicle, or any combination thereof.

The fluid moving device may comprise an impeller. The impeller may function to uptake air, deliver air to one or more heating elements, deliver air to a printed circuit board assembly, deliver air to an occupant, or any combination thereof. The impeller may fluidly communicate with one or more inlets. The impeller may fluidly communicate with one or more outlets.

The fluid moving device may be a radial blower or axial blower. The radial blower may direct air in a direction generally orthogonal to the rotational axis of the impeller. The axial blower may direct air in a direction co-axial with the rotational axis of the impeller.

The fluid moving device may operate at a variable speed. That is, the rotational speed of the impeller. Speed and/or operation mode (ON or OFF) may be controlled by pulse width modulation (PWM), constant current control, or the like. Speed and/or operation mode may be based on signals provided by one or more sensors (e.g., sensing the temperature of ambient air, sensing the temperature of the heating element, sensing the temperature of air expelled at an outlet, or any combination thereof), one or more setpoints, or both.

The setpoints may include a setpoint temperature, a setpoint speed, or both. The setpoints may be determined by an occupant (e.g., controlling via a human-machine interface), an autonomous climate system, or both. Control signals may be provided by one or more printed circuit board assemblies. The printed circuit board assembly may include that located in the PCBA portion of the housing, a dedicated printed circuit board assembly of the fluid moving device, or both.

The fluid moving device may draw in air from one or more inlets. The fluid moving device may expel air through one or more outlets. A first outlet may provide air to a heating element portion of a housing. The first outlet may be in fluid communication with one or more heating elements, one or more heat exchangers, a diffuser, or any combination thereof. A second outlet may provide air to a PCBA portion of a housing.

The inlet of the fluid moving device may be oriented downward from the vehicle seat. In other words, the inlet may be oriented toward a floor within the cabin of a vehicle. This arrangement may be advantageous to avoid the uptake of debris.

The location and/or orientation of the fluid moving device, one or more heating elements, one or more heat exchangers, and/or one or more conduits may be adapted to minimize airflow variation across a surface of the heating elements and heat exchangers and/or minimize variation of the temperature of expelled air across an area of the outlet. This may be achieved by providing a conduit with an axial offset from a longitudinal axis generally extending between a rotational axis of an impeller and a geometric center point of the profile of the heating elements and heat exchangers; a conduit with a cross-sectional area that varies (e.g., continuously) from an inlet of the conduit to an outlet of the conduit; providing one or more air directing members within a conduit, or any combination thereof.

The conduit may extend at an angle of about 5° or more, 10° or more, or even 20° or more. The conduit may extend at an angle of about 60° or less, 50° or less, or even 40°. The output temperature variation across the area of the outlet may be about 4° C. or less, more preferably about 2° C. or less, or even more preferably about 1° C. or less.

The fluid moving device may be integrated into the housing. That is, one or more constituent elements of the fluid moving device (e.g., impeller, motor, PCBA, or any combination thereof) may be provided within the housing.

The impeller may rotate about a rotational axis. Such rotation may be effectuated by a motor. The motor may comprise a rotor and stator. The rotor and the impeller may be coupled by a shaft.

The rotor and stator may be structurally independent from the heating module. That is, the heating module may be provided as a unitary construction with the impeller disposed within the housing and the rotor, via a shaft, may be removably coupled to the impeller. This arrangement may be advantageous in providing a fluid moving device with a standardized configuration and the ability to modularly install various motors to suit particular end-use applications.

By way of example, a required airflow (e.g., characterized in cubic feet per minute) for conditioning one body part may be less than or greater than a required airflow for conditioning another body part. Thus, a different motor may be employed during assembly of the heating module, the seat, and/or the vehicle. In providing a fluid moving device in this modular format, manufacturing cost and complexity may be mitigated.

The heating module may comprise one or more outlets. Outlet may refer to any orifice through which air is expelled and/or supplied to another portion of the heating module or vehicle cabin. The outlets may include an outlet that supplies air to a heating element portion of a housing and a conduit thereof. The outlets may include an outlet that supplies air to a PCBA portion of a housing and a conduit thereof. The outlets may include an outlet by which the heating element portion of a housing expels air to a cabin of a vehicle. The outlets may include an outlet by which the PCBA portion of a housing expels air to a cabin of a vehicle.

The heating module may comprise one or more inlets. Inlet may refer to any orifice through which uptake of air is effectuated and/or air is received by another portion of the heating module. The inlets may include an inlet through which an impeller draws in air from a vehicle cabin. The inlets may include an inlet by which a PCBA portion of a housing and a conduit thereof receives air from the impeller. The inlets may include an inlet by which the heating element portion of a housing and a conduit thereof receives air from the impeller.

The heating module may comprise a housing. The housing may function to direct an airflow; protect components of the heating module from dust, debris, and/or moisture; provide structural reinforcement to the heating module; provide the heating module with mounting points for coupling to a vehicle seat; or any combination thereof.

The housing may conform to an IEC Standard 60529 ingress protection rating. The heating module may be rated for dust protection, dust tightness, dripping water protection, spraying water protection, splashing water protection, or any combination thereof.

The housing may be fabricated from polymer. The polymer may include, but is not limited to, polyethylene, polypropylene, polyurethane, polyester, polyamide, polyvinylchloride, polyamide, polycarbonate, polymethylmethacrylate, the like, or any combination thereof. The housing may be fabricated by injection molding, co-injection molding, material addition (e.g., 3D printing), or any combination thereof.

The housing may comprise one or more segments, preferably two segments. Each of the segments may be structurally distinct and may couple together upon assembly. The segments may couple together by fasteners (e.g., screws), snap connections, adhesives, or any combination thereof. Snap connections may be advantageous for reducing manufacturing costs and complexity. A parting line between two or more segments may generally bisect a thickness of the heating module. However, the present disclosure contemplates that the parting line may be disposed closer to one side or the other of the heating module along the thickness thereof.

The snap connections may be in the form of a boss projecting from one segment of the housing and a tab projecting from another segment. The tab may comprise an orifice into which the boss locates upon assembly. Upon assembly, the tab may elastically deform when its free end slides onto and along the boss. The tab may elastically re-form when the free end has slid completely across the boss and the boss locates within the orifice.

The snap connections may be in the form of a recess formed into one segment of the housing and a tab projecting from another segment. The tab may have a finger at a free end thereof. The finger may locate within the recess. Upon assembly, the tab may elastically deform when the finger slides onto and across a segment. The tab may elastically re-form when the finger locates within the recess.

The snap connection may be located on an exterior of the housing or within enclosures defined by the housings. Snap connections located on the exterior of the housing may be advantageous for taking apart and reassembling the heating module after initial assembly.

The segments may be connected by one or more hinges. The hinge may be integrally formed to the segments. The hinge may be fastened to the segments. The hinge may elastically or plastically deform to close one segment onto another segment.

The housing may comprise a first, second, and third segment. The first segment may be located on the bottom of the heating module. That is, oriented toward the floor of a vehicle. The second and/or third segments may be located on the top of the heating module. That is, oriented toward an underside of a vehicle seat.

The first segment may define an enclosure for the printed circuit board assembly, the heating elements, the impeller, or any combination thereof. The second segment may define an enclosure for the printed circuit board assembly, the heating elements, or both. The third segment may define an enclosure for the impeller.

The present disclosure contemplates a different arrangement of the segments, such as the first segment defining an enclosure for the printed circuit board assembly, the heating element, or both; the second segment defining an enclosure for the printed circuit board assembly, the heating elements, the impeller, or any combination thereof; the third segment being eliminated and both the first and second segments defining an enclosure for the impeller; additional segments being employed (e.g., separate segments on the top of the heating module for respectively defining enclosures for the PCBA and heating elements); or the like.

The housing may comprise a printed circuit board assembly (PCBA) portion. The PCBA portion may function to house a PCBA, direct an airflow across a PCBA, distance a PCBA from one or more heating elements, or any combination thereof.

The PCBA portion may be provided an airflow that is separate from the airflow provided the heating element portion. The PCBA portion may be discrete from the heating element portion. That is, the PCBA portion may define an enclosure that is discrete from an enclosure defined by the heating element portion.

The PCBA portion may be structurally attached to the heating element portion by a conduit, a segment through which heating element connectors extend, a channel through which sensor wires extend, or any combination thereof. One or more other structural bridges between the PCBA portion and the heating element portion may be employed. At least one segment of the housing may be continuous across the PCBA portion, the heating element portion, the fluid moving device portion, or any combination thereof, thus structurally connecting said portions.

The PCBA portion may be distanced from the heating element portion. In this manner, heat from the heating elements may be precluded from conductively and/or convectively migrating to the PCBA.

The PCBA portion may comprise a first side oriented toward the fluid moving device portion and/or heating element portion. The PCBA portion may comprise a second side oriented away from the fluid moving device portion and/or heating element portion. It may be advantageous to locate the PCBA abutting or at least proximal to the first side of the PCBA portion to distance the PCBA away from the heating elements.

The printed circuit board may be oriented vertically within the PCBA portion. That is, one edge of the printed circuit board may be oriented toward an underside of a vehicle seat and an opposing edge of the PCBA may be oriented toward a floor of the cabin of a vehicle, in reference to when the heating module is installed in or on a vehicle seat. In this configuration, heat migration from the heating element to the PCBA may be mitigated or even eliminated. By way of example, if the printed circuit board assembly were oriented horizontally, then one edge of the printed circuit board assembly may be located proximate to the heating elements or at least proximate to portions of the housing that may conduct heat from the heating element.

The PCBA portion may comprise one or more outlets. The outlet may expel air to a vehicle cabin. The direction of the airflow expelling from an outlet of the PCBA portion may oppose the direction of the airflow expelling from an outlet of the heating element portion. The outlet of the PCBA portion may be located on a first end of the heating module that opposes a second end of the heating module where the outlet of the heating element portion may be located.

The housing may comprise one or more conduits. The housing may comprise a conduit that fluidly communicates with heating elements and/or a diffuser, a conduit that fluidly communicates with a PCBA portion, or both. The conduit fluidly communicating with the PCBA portion may branch off from the fluid moving device portion.

The conduit fluidly communicating with the PCBA portion may extend at an angle relative to a longitudinal axis of the heating module as defined herein. The angle may be about 30° or more or even 45° or more. The angle may be about 75° or less, or even 90° or less.

The conduit of the PCBA portion may extend generally toward an end of the heating module in opposing relationship to an end where the PCBA portion outlet is located (e.g., toward an end of the heating module where the heating element portion outlet is located). In this manner, air may travel to a closed end of the PCBA portion and then travel back toward the outlet. This arrangement may be advantageous to ensure airflow across the entirety of the PCBA.

The conduit of the heating element portion may extend generally straight from the inlet to the outlet. The conduit of the heating element portion may be free of any bends, turns, or both.

The housing may comprise one or more air directing members. The air directing member may function to mitigate variations of airflow across a surface of the heating elements and/or heat exchangers.

The air directing members may be integral to the housing (e.g., integrally molded thereto) and/or fastened to the housing (e.g., via fasteners, adhesive, or both). The air directing members may project from the housing. The air directing members may be oriented generally orthogonal to a surface of the housing from which they project. The air directing members may be disposed on a first and/or second segment of the housing.

Air directing members of the first segment may contact air directing members of the second segment. That is, free ends thereof opposing the ends at which the air directing members project from the housing may contact. Air directing members of the first and second segments may define a gap between the free ends thereof.

The free ends of the air directing members disposed on only the first or second segments may contact the opposing segment. Air directing members disposed on only the first or second segments may define a gap between the free ends of the air directing members and the opposing segment.

The heating module may comprise one or more diffusers. The diffuser may function to direct an airflow, diffuse an airflow, prevent access to the heating element, or both. The diffuser may be provided air by one or more outlets of a heating element portion of the housing.

The diffuser may be removably coupled to the housing. In this regard, the segments may be assembled first and then the diffuser assembled to the segments. The diffuser may be coupled to the housing with fasteners (e.g., screws), adhesives, or both.

The configuration of the diffuser may be selected according to the end-use while the rest of the housing may remain the same. In providing a diffuser in this modular format, manufacturing costs and complexity may be mitigated, and a unitary heating module may be provided to suit a variety of end-use applications. For instance, a diffuser directing airflow in one direction may be required for some applications while a diffuser directing airflow in two directions may be required in other applications.

The diffuser may direct airflow in one or more, two or more, or even three or more directions. By way of example, a diffuser directing airflow in two directions may be suitable to direct airflow to both legs of an occupant.

The diffuser may be generally planar. A generally planar diffuser may direct air in one direction. The diffuser may be generally Y-shaped. The generally Y-shaped diffuser may direct air in two directions. The generally Y-shaped diffuser may have two conduits branching off from a common conduit. The common conduit may couple to an outlet of the housing.

The diffuser may comprise a grille. The grille may extend over the outlet. The grille may function to prevent access to the heating element by objects or persons. The grille may prevent persons from burning themselves on the heating elements. The grille may prevent debris from entering the outlet and contacting the heating elements.

The heating module may comprise one or more printed circuit board assemblies (PCBAs). The PCBA may function to power the fluid moving device and/or heating elements, direct the speed of the fluid moving device, direct the temperature of the heating elements, signally communicate with other vehicle systems (e.g., controllers), or any combination thereof.

The PCBA may signally communicate with a vehicle's parent controller via local interconnect network (“LIN”) signals. The PCBA may be powered by the vehicle battery. The PCBA may comprise a power connector and/or a LIN connector. The power connector and the LIN connector may be provided as separate connectors or a single integrated connector. The heating module may be compliant to LIN 2.1. The heating module may be a LIN child (i.e., in a parent/child arrangement). The heating module may be able to change software parameters via LIN. The embedded software and EEPROM content may be programmable via LIN.

A PCBA may be disposed within the PCBA portion of the housing, within a fluid moving device portion of the heating module, or both. The heating module may comprise a PCBA dedicated to the heating elements and a PCBA dedicated to the fluid moving device. The PCBAs may have a parent/child relationship.

The heating module may comprise one or more sensors. The sensors may function to measure temperature, signally communicate with the PCBA, or both. Two sensors may be employed to obtain an average of temperature measurements, although the present teachings contemplate employing one sensor or even more than two sensors.

The sensors may sense the temperature of ambient air. The temperature may be communicated via a signal. Signals from the sensors may be employed to control the speed of the fluid moving device and/or the temperatures of the one or more heating elements.

The sensors may include a negative temperature coefficient thermistor. Although, other types of temperature sensors may be within the scope of the present teachings.

The sensors may protrude from a PCBA portion of the housing. In this regard, the sensors may be exposed to the ambient air surrounding the housing. The sensors may protrude into a space between the PCBA portion, the heating element portion, a conduit extending between the fluid moving device and the PCBA portion, a connection between the PCBA portion and the heating element portion (e.g., where wires connecting the heating elements to the PCBA extend), or any combination thereof. Thus, the sensors may be provided at least partial protection by the housing.

The present teachings contemplate that waste heat from the printed circuit board assembly may have an effect upon sensors protruding from the PCBA portion. At least one avenue for this waste heat may include the housing through which heat conducts.

The sensors may be located at the inlet of the fluid moving device. The sensors may be located within the housing at the inlet, external to the housing at the inlet, or both. The present teachings contemplate that placement of the sensors in this location may influence the airflow being pulled into the inlet. Moreover, the packaging space of the heating module may not provide for a space for the sensors within the housing at the inlet without interfering with the impeller, and that locating the sensors external to the housing may expose the sensors to damage.

The sensors may be located in the conduit extending between the fluid moving device and the PCBA portion. In this regard, the sensors may be protected within the housing. Waste heat may continue to influence the sensors in this location.

The housing may comprise a channel. The channel may function to house the sensors and/or associated wires, locate the sensors a distance from the PCBA portion, or both. The channel may extend from the PCBA portion. The channel may extend toward the heating element portion. The channel may connect the PCBA portion and the heating element portion.

The channel may distance the sensors from waste heat sources, locate the sensors in an area that is protected from contact during handling and/or use of the heating module, protect wires connecting the sensors to the printed circuit board assembly, or any combination thereof. In regards, to waste heat, generally, the longer the extent of the channel, the lesser the influence of waste heat conducting along the material of the channel.

The channel may be in-plane with the fluid moving device portion, the PCBA portion, and the heating element portion. The channel may protrude into a space between the PCBA portion, the heating element portion, a conduit extending between the fluid moving device and the PCBA portion, a connection between the PCBA portion and the heating element portion (e.g., where wires connecting the heating elements to the PCBA extend), or any combination thereof.

The channel may extend toward the fluid moving device portion, the heating element portion, or both. The channel may terminate proximate to (e.g., 4 cm or less, more preferably 3 cm or less, more preferably 2 cm or less, or even more preferably 1 cm or less) the housing of the fluid moving device, the heating element portion, or both. In this regard, the sensors may be exposed to ambient air external of the housing.

The heating elements and/or a PCBA within the fluid moving device portion may generate waste heat. Heat generated by the PCBA may be less than that generated by the heating elements. Thus, the channel may terminate closer to the fluid moving device portion than the heating elements. The channel may terminate proximate to (e.g., 4 cm or less, more preferably 3 cm or less, more preferably 2 cm or less, or even more preferably 1 cm or less) the fluid moving device portion, the channel may terminate at a mid-point between the fluid moving device and the heating elements, or anywhere therebetween.

The channel may connect the PCBA portion with the heating element portion. The channel may have a first end at the heating element portion and a second end at the PCBA portion. The first end may expose the sensors to the airflow within the heating element portion. The first end may be located proximate to (e.g., 4 cm or less, more preferably 3 cm or less, more preferably 2 cm or less, or even more preferably 1 cm or less) an outlet of the fluid moving device and/or the parting line between the fluid moving device portion and the heating element portion of the housing. In this regard, the sensors may be exposed to ambient air that is drawn from the cabin, prior to being conditioned by the heating elements. The sensors may be located upstream of the heating elements and downstream of the fluid moving device.

Location of the sensors within the heating element portion and in contact with the airflow thereof may provide an accurate temperature measurement of ambient air. The difference between the temperature sensed by the sensors and the actual ambient air temperature may be about 5° C. or less, 4° C. or less, or even 3° C. or less.

The second end may be located proximate to (e.g., 4 cm or less, more preferably 3 cm or less, more preferably 2 cm or less, or even more preferably 1 cm or less) connection points on the printed circuit board assembly to which wires of the sensors connect. In this regard, the lengths of the wires may be minimized.

The channel may receive an airflow originating from the heating element portion of the housing, the PCBA portion of the housing, or both. The channel may have a dimension that is generally equal to a dimension of the wires and/or trenches formed in the channel may have dimensions that are generally equal to the sensors. In this manner, airflow leaking through the channel may be negligible. It may be advantageous to mitigate or even prevent the airflow from entering the channel. In this regard, turbulent airflow within the heating element portion of the housing and/or the PCBA portion of the housing may be mitigated or even prevented. One benefit to managing turbulent airflow may include the reduction in noise produced by the heating module.

The channel may include a sealant, a gasket, or otherwise to seal or at least substantially seal the channel from airflow.

The channel may have a shape that is stepped, linear, curved, or any combination thereof. The shape of the channel may be directed by the shortest path between the connection points on the printed circuit board assembly and the desired location of the sensors exposed within the heating element portion.

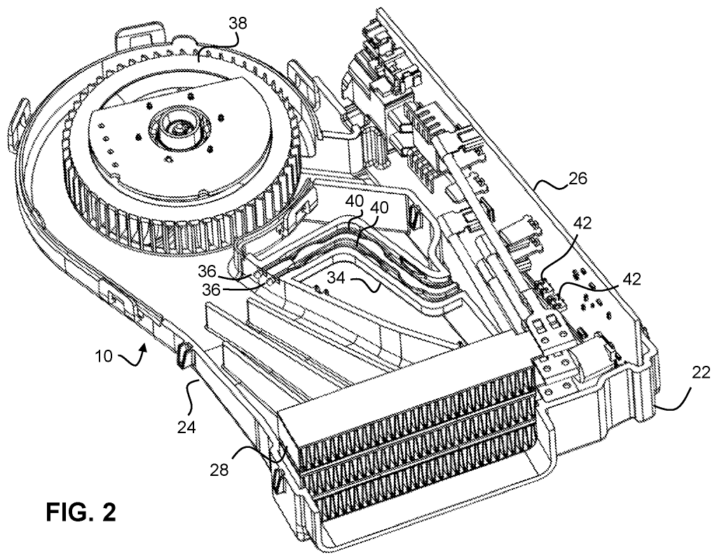

As illustrated in FIG. 2, the channel has a stepped shape. However, the present disclosure contemplates that the connection points for the sensor wires can be relocated on the PCBA such that the channel extends straight from the sensor locations depicted in FIG. 2, to the PCBA portion of the housing.

The channel may comprise a partition that separates the wires of separate sensors. In this regard, assembly may be aided by providing dedicated locations for the wires. The partition may define sub-channels through which the wires of each sensor may extend. The partition may extend from the first portion of the housing and/or the second portion of the housing. The partition may extend at least partially between the first and second ends of the channel.

The partition may extend partially between the first and second portions of the housing. Thus, a gap may be defined between a free end of the partition and the first or second portion, whichever portion the partition does not extend from. Upon assembly, the gap may ensure that wires errantly crossing in between sub-channels are not pinched between the first and second portions.

The sub-channels may comprise one or more retention features. The retention features may function to retain the wires within the sub-channels. The retention features may extend from walls of the sub-channels, from the partition, or both. The retention features may define spaces in the sub-channels in which the wires may locate. The spaces may have a dimension that is less than, equal to, or greater than a collective cross-sectional dimension of the wires located within the sub-channel.

Preferably, the dimensions of the spaces may be less than the collective cross-sectional dimension of the wires such that the wires are pinched. In this regard, the wires can be secured and prevented from migrating during assembly and/or use of the heating module. The wires may be pinched between the walls and the retention features, between the partition and the retention features, or both.

The retention features may have a profile of a rounded (e.g., circular) segment, square, rectangle, triangle, or any combination thereof. Any suitable profile of the retention features, projecting from the walls and/or sub-channels may be contemplated by the present teachings. A rounded (e.g., circular) segment may be preferable to avoid the presence of sharp edges.

The retention features may be located along the length of the channel or at least a portion thereof. The distance between adjacent retention features may be generally equal to or different from the distance between other adjacent retention features. The retention features may be located at regular intervals along the length of the channel.

The retention features may alternate, along a length of the sub-channels, in projecting from the walls and projecting from the partition. The retention features may project from only the walls of the channel or only the partition of the channel.

The retention features may be located on the first and/or second segments of the housing.

The channels may comprise a trench for each sensor. The trenches may function to secure the sensors. The trenches may have a cross-sectional dimension that is less than a dimension of the sensors. Typically, the sensors may have a bulb shape. Thus, the largest cross-sectional dimension may be the largest diameter of a sensor. In this regard, the sensors may be prevented from retracting into the sub-channels.

The trenches may be defined by a reduced cross-sectional dimension relative to the sub-channels. The trenches may include chamfers transitioning from the cross-sectional dimension of the sub-channels to the cross-sectional dimensions of the trenches.

The retention features may include those that are located proximate to the chamfer such that the area defined therebetween is less than the largest dimension of the sensors. In this regard, the sensors cannot be placed within the sub-channels, in the area between the retention features and the trenches, during assembly.

The trenches may be separated by a wall that maintains a spacing between multiple sensors. The wall may prevent adjacent sensors from contacting each other. Sensors that contact each other may negatively impact the performance thereof.

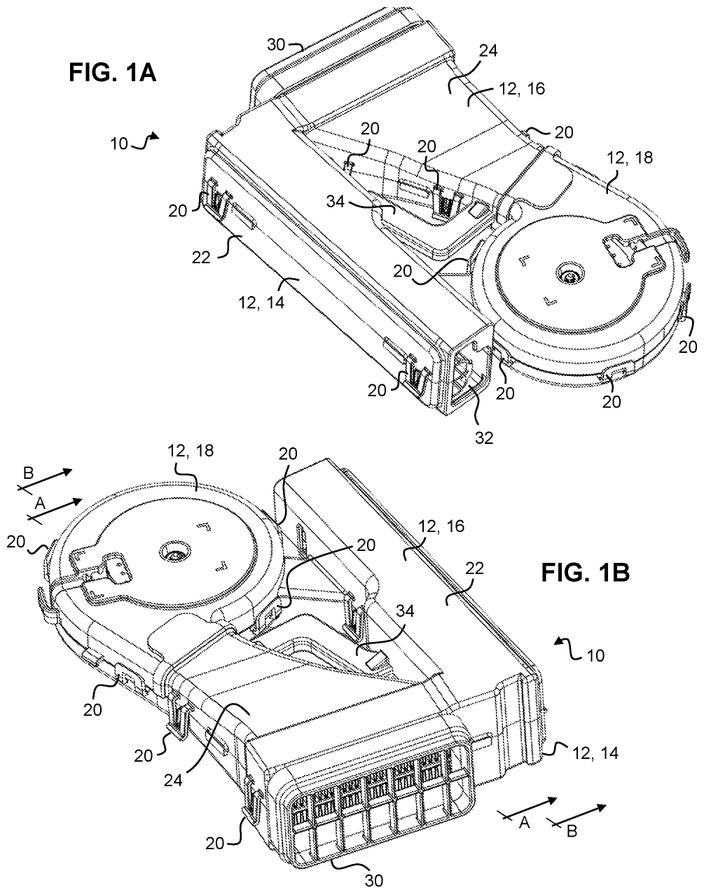

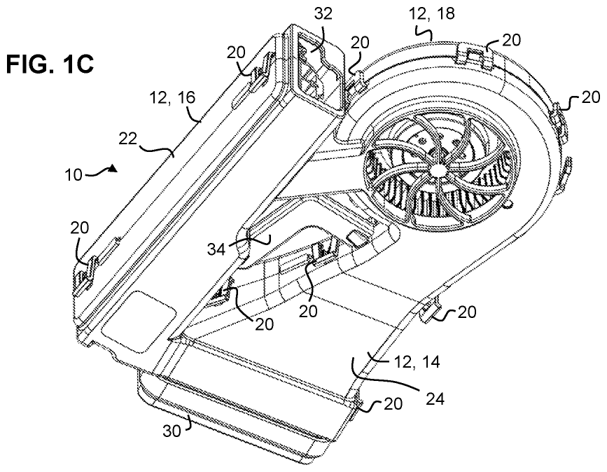

FIG. 1A through FIG. 1C shows a heating module 10 according to the present disclosure. The heating module 10 comprises a housing 12 having a first, second, and third segment 14, 16, 18. The first segment 14 is continuous along the bottom of the heating module 10 and the second and third segments 16, 18 are disposed on the top of the heating module 10.

“Top” and “bottom” are used with respect to FIG. 1A through FIG. 1C in regard to an installation whereby the inlet of the fluid moving device, discussed below, is oriented toward the floor of a vehicle. However, the present teachings contemplate that any orientation of the heating module 10 may be used and accordingly, “top” and “bottom” may be substituted for other suitable descriptors.

The first segment 14 is bi-sectionally separated from the second and third segments 16, 18, however, the present teachings contemplate the parting line being located on any plane extending through the heating module 10. The second and third segments 16, 18 are separated by a parting line therebetween. The third segment 18 generally extends over the impeller 38, shown in FIG. 2.

The third segment 18 can comprise a printed circuit board assembly for controlling the operation of the impeller 38 and a motor may be disposed upon the third segment 18 to mechanically couple to the impeller 38 in a modular manner. The impeller 38, printed circuit board assembly, motor, third segment, first segment in the region of the impeller 38, or any combination thereof may be comprised by the fluid moving device described herein.

The first, second, and third segments 14, 16, 18 couple to each other via a plurality of snap connections 20. As depicted, the snap connections between the first and second segments 14, 16 comprise a boss projecting from the first segment 14 and a tab extending from the second segment 16 and toward the first segment 14. The tab has an orifice into which the boss locates upon assembly. In this regard, as the two segments are joined together, the tab elastically deforms when its free end slides onto and along the boss, and then elastically re-forms when the free end has slid completely across the boss and the boss locates within the orifice. The present disclosure contemplates any suitable snap connection construction.

With respect to the joining of the first segment 14 with the third segment 18, the locations of the boss and tab are inverted. That is, the first segment 14 comprises the tab and the third segment 18 comprises the boss. The present disclosure contemplates any location of the snap connections on the first, second, and third segments.

The heating module 10 comprises a first portion 22 and a second portion 24. The first portion 22 houses a printed circuit board assembly 26 and the second portion 24 houses a heating element 28, as shown in FIG. 2. An impeller 38, as shown in FIG. 2, provides an airflow to the first and second portions 22, 24. The airflow through the first portion 22 draws waste heat away from the printed circuit board assembly 26 and the airflow through the second portion 24 thermally interacts with the heating element 28 and ultimately interacts with a vehicle occupant.

A diffuser 30 is disposed on the housing 12, downstream of the heating element 28. The airflows exit the first portion 22 through an outlet 32 and exit the second portion 24 through the diffuser 30.

The first and second segments 14, 16 define a channel 34 extending between and connecting the first and second portions 22, 24.

FIG. 2 is a perspective view of the heating module 10 with the second and third segments 16, 18, depicted in FIG. 1A through FIG. 1C, removed. Thus, the inside of the channel 34 and the enclosures within the first, second, and third segments 14, 16, 18 of the housing 12 are exposed.

Two sensors 36 are exposed at one end of the channel 34 terminating at the second portion 24 of the heating module 10. The sensors 36 are exposed to the airflow forced into the second portion 24 by the impeller 38. The sensors 36 measure the temperature of ambient air, prior to being heated by the heating element 28. In this regard, the temperature of the heating element 28 and/or the speed of the impeller 38 may be controlled based at least in part on said temperature.

The sensors 36 are connected to the printed circuit board assembly 26 via wires 40 that extend through the channel 34 and exit an opposing end thereof, the opposing end terminating at the first portion 22. The printed circuit board assembly 26 comprises connection points 42 to which the wires 38 attach.

One consideration in the construction of the heating module 10 is waste heat generated by the printed circuit board assembly 26 and the heating element 28. While the airflows convectively draw waste heat away from the same, the waste heat can conduct through the housing 12 and/or radiate from these heat sources. It is one object of the present teachings to locate the sensors 36 to mitigate or even prevent the conductive and/or radiative effects of the waste heat from skewing the temperature measurements of the sensors 36. Thus, the sensors 36 are distanced from both the printed circuit board assembly 26 and the heating element 28.

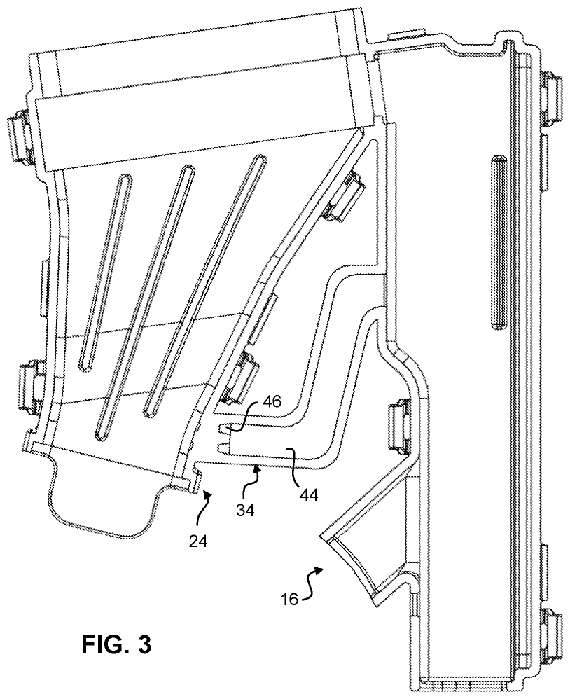

FIG. 3 shows the second segment 16 of the housing 12. Specifically, the side that orients toward the first segment 14 upon assembly. Thus, the inside of the channel 34 is exposed. The channel 34 comprises a recess 44 extending substantially the length of the channel 34. At the end of the channel 34 terminating at the second portion 24, chamfers 46 are located; one for each sensor 36. The chamfers 46 reduce by a cross-sectional dimension from the recess 44 to the second portion 24.

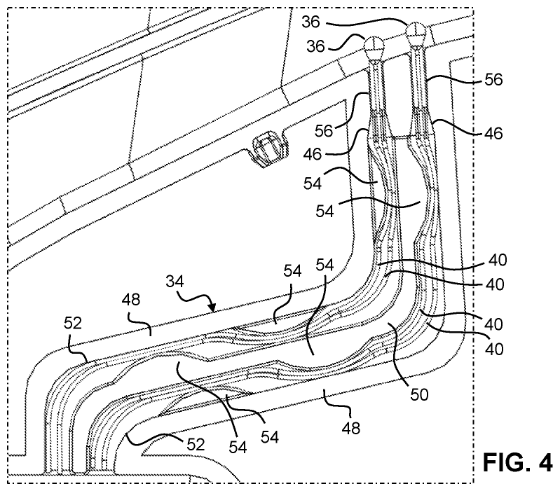

FIG. 4 shows the channel 34 on the first segment 14 of the housing 12. The channel 34 comprises opposing walls 48 and a partition 50 therebetween to define two sub-channels 52 within which the wires 40 of each respective sensor 36 are located.

Retention features 54 are disposed along the lengths of the sub-channels 52. The retention features 54 alternate in projecting from the walls 48 and the partition 50, although the present disclosure contemplate retention features 54 projecting only from the walls 48, only from the partition 50, or in a combination thereof that may not be in alternating manner.

Spaces are defined between the retention features 54 and the walls 48 and between the retention features 54 and the partition 50. The spaces may have a dimension that is less than the largest dimension of the wires 40 (i.e., as depicted, a combined dimension of two wires 40). In this regard, the wires 40 are pinched between the retention features and the partition 50, between the retention features and the walls 48, or both. The present teachings contemplate that the spaces have a dimension that is generally equal to or even greater than the largest dimension of the wires 40.

The channel 34 comprises trenches 56 for each sensor. The trenches 56 have a cross-sectional dimension that is less than the cross-sectional dimension of the sub-channels 52 and the largest dimension of the sensors 36. In this regard, the sensors 36, once placed within the trenches 56, are prevented from retracting into the sub-channels 52. As depicted, the sensors 36 are characterized by a bulb shape, and thus, the trenches 56 have a dimension that is smaller than the largest diameter of the bulbs.

Chamfers 46 are located between the trenches 46 and the sub-channels 52. The cross-sectional dimensions of the chamfers 46 reduce from the sub-channels 52 to the trenches 46. The space between the chamfers 46 and the nearest retention features 54 are smaller than the largest dimension of the sensors 36. In this regard, during assembly, it would not be possible to misassemble the heating module 10 and fit the sensors 36 within the space between the chamfers 46 and the retention features 54 nearest thereto.

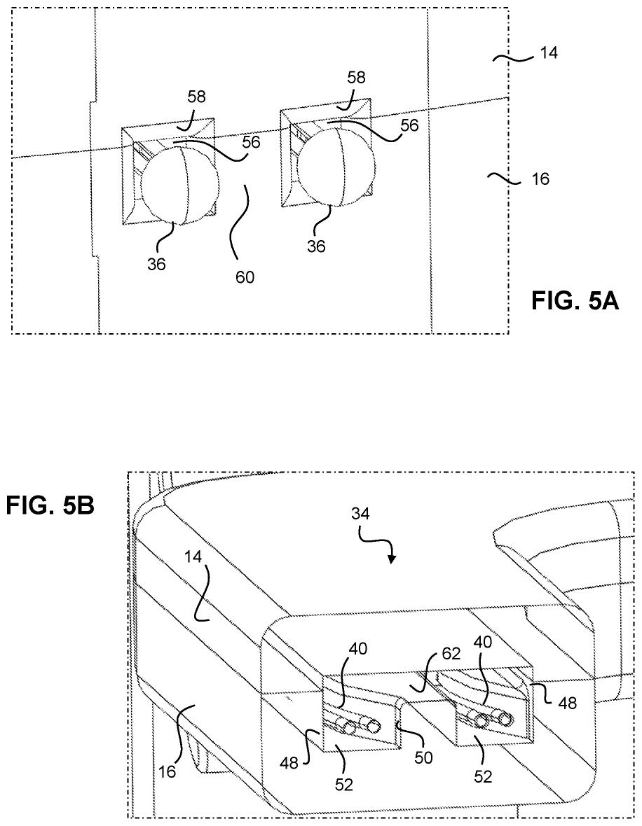

FIG. 5A shows the sensors 36 exposed within the second portion 24 of the housing 12. The sensors 36 are disposed between the first segment 14 and the second segment 16, a parting line being disposed therebetween.

Fillets 58 are defined at the ends of the trenches 56 where the sensors 36 are exposed. The fillets 58 ensure that no sharp corners are present that may damage the sensors 36 and/or wires 40. The fillets 58 define a region in which a portion of the bulb shape of the sensors 36 can be recessed into the trenches 56. In this regard, the profile of the sensors 36 exposed to the airflow within the second portion 24 can be reduced and thus, the influence of the sensors 36 on the airflow (e.g., causing turbulence) can be mitigated.

A wall 60 is disposed between the two sensors 36 to maintain a spacing therebetween such that they do not touch.

FIG. 5B shows the channel 34 formed by assembly of the first and second segments 14, 16. A gap 62 is defined between the first and second segments 14, 16. In this regard, pinching of the wires therebetween can be avoided during assembly when the first and second segments 14, 16 are joined. The sub-channels 52 therein are defined between the walls 48 and the partition 50. The gap 62 is located between the first segment 14 and the partition 50 projecting from the second segment 16.

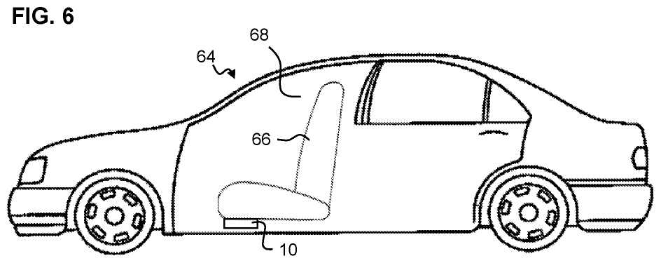

FIG. 6 shows a vehicle 64. A seat 66 is located within the cabin 68 of the vehicle. A heating module 10 according to the present teachings is attached to the seat 66. In the depicted configuration, the heating module 10 can expel air toward the legs of a seated occupant. The heating module 10 of the present teachings does not require coolant lines extending from forward of the firewall (e.g., from an internal engine cooling system) into the cabin 68.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Many embodiments as well as many applications besides the examples provided will be apparent to those of skill in the art upon reading the above description.

It is understood that the above description is intended to be illustrative and not restrictive. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Other combinations are also possible as will be gleaned from the following claims, which are also hereby incorporated by reference into this written description.

Plural elements can be provided by a single integrated element. Alternatively, a single element might be divided into separate plural elements. The disclosure of “a” or “one” to describe an element is not intended to foreclose additional elements.

While the terms first, second, third, etc., may be used herein to describe various elements, components, regions, layers, and/or sections, these elements, components, regions, layers, and/or sections should not be limited by these terms. These terms may be used to distinguish one element, component, region, layer, or section from another region, layer, or section. Terms such as “first”, “second”, and other numerical terms when used herein do not imply a sequence or order unless clearly indicated by the context. Thus, a first element, component, region, layer, or section discussed herein could be termed a second element, component, region, layer, or section without departing from the teachings.

Spatially relative terms, such as “inner”, “outer”, “beneath”, “below”, “lower”, “above”, “upper”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value is, for example, from 1 to 90, from 20 to 80, or from 30 to 70, it is intended that intermediate range values such as (e.g., 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

### REFERENCE NUMERALS

10 Heating module
12 Housing
14 First segment
16 Second segment
18 Third segment
20 Snap connection
22 First portion
24 Second portion
26 Printed circuit board assembly
28 Heating element
30 Diffuser
32 Outlet
34 Channel
36 Sensor
38 Impeller
40 Wire
42 Connection point
44 Recess
46 Chamfer
48 Wall
50 Partition
52 Sub-channel
54 Retention feature
56 Trench
58 Fillet
60 Wall
62 Gap
64 Vehicle
66 Seat
68 Cabin

What is claimed is:

1. A heating module comprising:
a housing comprising:
a first portion in which a printed circuit board assembly is located,
a second portion in which a heating element is located, and
a channel extending from the first portion toward the second portion; and
a sensor connected to the printed circuit board assembly via a wire extending through the channel,
the sensor being exposed at an end of the channel.

2. The heating module according to claim 1, wherein the channel connects the first portion and the second portion.

3. The heating module according to claim 1, wherein the sensor measures ambient air received into the second portion of the housing via a blower.

4. The heating module according to claim 3, wherein the sensor extends into an airflow generated by the blower and travelling between opposing ends of the second portion.

5. The heating module according to claim 4, wherein the sensor is located upstream of the heating element and downstream of the blower.

6. The heating module according to claim 5, wherein the sensor is located proximate to an outlet of the blower and/or a parting line between the outlet of the blower and the second portion.

7. The heating module according to claim 6, wherein the end of the channel, being a first end, is proximate to the outlet of the blower and/or the parting line and a second end of the channel is proximate to a connection point of the wire to the printed circuit board assembly.

8. The heating module according to claim 7, wherein the channel has a stepped shape, linear shape, curved shape, or any combination thereof.

9. The heating module according to claim 8, wherein the sensor is a first sensor, and the heating module comprises a second sensor connected to the printed circuit board assembly and exposed at the first end of the channel.

10. The heating module according to claim 9, wherein the housing comprises a first segment and a second segment, which fasten together to define enclosures within the first portion, the second portion, and the channel; and wherein the first segment and the second segment fasten together by snap connections integrally formed to the first and second shells, separate fasteners, or both.

11. The heating module according to claim 10, wherein the channel comprises a partition that separates the wire of the first sensor and the wire of the second sensor and defines a first and second sub-channel through which the wire of the first sensor and the wire of the second sensor respectively extend; wherein the partition projects from the first segment or the second segment and extends at least partially between the first and second ends of the channel; and wherein the partition extends partially between the first and second segments such that a gap is defined between a free end of the partition and the first or second segment, whichever the partition does not extend from.

12. The heating module according to claim 11, wherein the first and second sub-channels each comprise one or more retention features projecting from a wall of the first and second sub-channels and/or projecting from the partition; wherein the one or more retention features define spaces between the one or more retention features and the wall and/or the one or more retention features and the partition; and wherein the spaces have a dimension that is less than a cross-sectional dimension, respectively, of the wires of the first and second sensor such that the wires are pinched within the spaces.

13. The heating module according to claim 12, wherein the one or more retention features have a profile of a circular segment, square, rectangle, triangle, or any combination thereof.

14. The heating module according to claim 13, wherein the one or more retention features alternate, along a length of the first and second sub-channels, in projecting from the wall of the first and second sub-channels and projecting from the partition.

15. The heating module according to claim 14, wherein the one or more retention features are located on the first segment and/or second segment of the housing.

16. The heating module according to claim 15, wherein the channel comprises a first trench for the first sensor and a second trench for the second sensor, the first and second trenches respectively securing the first and second sensors; and wherein cross-sectional dimensions of the first and second trenches are less than largest dimensions of the first and second sensors such that the first and second sensors are prevented from retracting into the first and second sub-channels.

17. The heating module according to claim 16, wherein the first and second trenches are defined by a reduced cross-sectional dimension relative to the first and second sub-channels; and wherein the first and second trenches respectively include a first and second chamfer transitioning from the cross-sectional dimension of the first and second sub-channels to the reduced cross-sectional dimensions of the first and second trenches.

18. The heating module according to claim 17, wherein the one or more retention features in each of the first and second sub-channels include a retention feature in each of the first and second sub-channels located proximate to the chamfer such that the area defined between the retention feature in each of the first and second sub-channels and the first and second chamfers is less than a dimension of the first and second sensors, respectively.

19. The heating module according to claim 18, wherein the first and second trenches are separated by a wall that maintains a spacing between the first and second sensors.

20. The heating module according to claim 9, wherein the blower provides a first airflow to the first portion of the housing containing the printed circuit board assembly, and a second airflow to the second portion of the housing containing the heating element; wherein the first airflow draws heat away from the printed circuit board assembly, and the second airflow is heated by the heating element and expelled from the heating module to thermally condition a passenger of a vehicle; and wherein signals from the first and second sensors are employed to control the speed of an impeller of the blower and/or the temperature of the heating element.
